(19) United States
(12) Patent Application Publication
(10) Pub. No.: US 2015/0091789 A1
(43) Pub. Date: Apr. 2, 2015

(54) ELECTRONIC DEVICE WITH A HEADS UP DISPLAY

(71) Applicant: Mario E. Alzate, Rio Rancho, NM (US)

(72) Inventor: Mario E. Alzate, Rio Rancho, NM (US)

(21) Appl. No.: 14/040,665

(22) Filed: Sep. 28, 2013

(51) Int. Cl. G02B 27/01; G06F 3/01

(52) U.S. Cl. CPC G02B 27/0172; G02B 27/0101; G06F 3/017; G02B 2027/0138
USPC 345/156; 359/630

(57) ABSTRACT

Particular embodiments described herein provide for an electronic device that can include a circuit board coupled to a plurality of electronic components (which may include any type of components, elements, circuitry, etc.). One particular example implementation of an electronic device may include a display portion that includes: a display to be provided in front of an eye of a user; and a lens portion that includes a micro lens array and a convex lens, where the micro lens array and the convex lens cooperate in order to render a virtual image of an object to the user.

### TECHNICAL FIELD

Embodiments described herein generally relate to heads up displays for an electronic device.

### BACKGROUND

End users have more electronic device choices than ever before. A number of prominent technological trends are currently afoot (e.g., more computing devices, more displays, etc.), and these trends are changing the electronic device landscape. One of the technological trends are heads up displays (e.g., optical head mounted displays (OHMD), head mounted displays, etc.). In general, heads up displays are a display a user wears on their head in order to have video information directly displayed in front of an eye. Lenses and other optical components are used to give the user the perception that the images are coming from a greater distance. Most of the various techniques for heads up displays often mount the display somewhere other than in front of the eye and require set of optics to bring the image in front of the eye. As a result, heads up displays on the market today are typically considered heavy, obtrusive, non-discreet, or bulky. Hence, there is a need for an electronic device configured to reduce the complexity and size of the required optics necessary to bring a display in front of an eye of a user

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an electronic device, in accordance with one embodiment of the present disclosure;

FIG. 1B is a simplified orthographic view illustrating an embodiment of an electronic device, in accordance with one embodiment of the present disclosure;

FIG. 2 is a simplified side view illustrating an embodiment of a portion of an electronic device, in accordance with one embodiment of the present disclosure;

FIG. 3 is a simplified side view illustrating an embodiment of a portion of an electronic device, in accordance with one embodiment of the present disclosure;

FIG. 4A is a simplified side view illustrating an embodiment of a portion of an electronic device in accordance with one embodiment of the present disclosure;

FIG. 4B is a simplified side view illustrating an embodiment of a portion of an electronic device in accordance with one embodiment of the present disclosure;

FIG. 5A is a simplified side view illustrating an embodiment of a portion of an electronic device, in accordance with one embodiment of the present disclosure;

FIG. 5B is a simplified side view illustrating an embodiment of a portion of an electronic device, in accordance with one embodiment of the present disclosure;

FIG. 6 is a simplified orthographic view illustrating an embodiment of a portion of an electronic device, in accordance with one embodiment of the present disclosure;

FIG. 7 is a simplified orthographic view illustrating an embodiment of an electronic device, in accordance with one embodiment of the present disclosure;

FIG. 8 is a simplified orthographic view illustrating an embodiment of a portion of an electronic device, in accordance with one embodiment of the present disclosure;

FIG. 9 is a simplified orthographic view illustrating an embodiment of an electronic device, in accordance with one embodiment of the present disclosure; and

FIG. 10 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Overview

Particular embodiments described herein provide for an electronic device that can include a circuit board coupled to a plurality of electronic components (which may include any type of components, elements, circuitry, etc.). One particular example implementation of an electronic device may include a display portion that includes: a display provided in front of an eye of a user; and a lens portion that includes a micro lens array and a convex lens, where the micro lens array and the convex lens cooperate in order to render a virtual image of an object to the user. The virtual image and the object can include any graphic, picture, hologram, figure, picture, illustration, representation, likeness, impression, etc., any of which could be viewed in the course of using any type of computer.

In other embodiments, the virtual image can be rendered between the display and the convex lens. The micro lens array can comprise at least one Fresnel lens. In addition, the display can include a plurality of pixels and the micro lens array includes a plurality of lenses, and each lens in the plurality of lenses corresponds to a pixel in the plurality of pixels. In certain embodiments, the electronic device can include a camera configured to allow the user to define a viewpoint for the virtual image. The camera is configured to capture at least one hand motion by the user for interaction with the display. In at least one embodiment, the distance between the display and the micro lens array is less than five (5) millimeters.

### Example Embodiments

The following detailed description sets forth example embodiments of apparatuses, methods, and systems relating to detachable display configurations for an electronic device. Features such as structure(s), function(s), and/or characteristic(s), for example, are described with reference to one embodiment as a matter of convenience; various embodiments may be implemented with any suitable one or more of the described features.

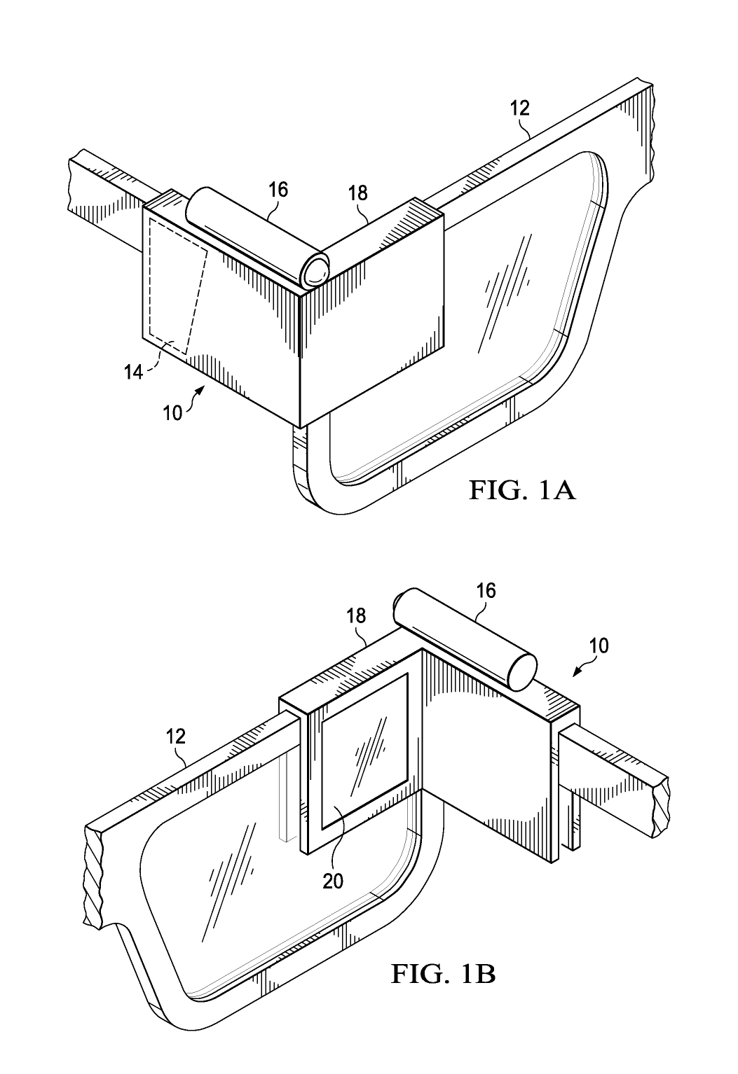

FIG. 1A is a simplified orthographic view illustrating an embodiment of an electronic device 10 in accordance with one embodiment of the present disclosure. Electronic device 10 may include a controller 14, a camera 16, and a body portion 18. In an embodiment, electronic device 10 may be worn on or attached to eyeglasses 12. Eyeglasses 12, (also known as glasses or spectacles) can include frames with lenses worn in front of the eyes of a user. The lenses may be for aesthetic purposes or for eye protection against flying debris or against visible and near visible light or radiation (e.g., sunglasses allow better vision in bright daylight, and may protect one's eyes against damage from high levels of ultraviolet light). The lenses may also provide vision correction.

Turning to FIG. 1B, FIG. 1B is a simplified orthographic view illustrating an embodiment of an electronic device 10 on eyeglasses 12 in accordance with one embodiment of the present disclosure. Electronic device 10 may include camera 16, body portion 18, and a display portion 20. Camera 16 is configured to capture video data. Electronic device 10 can be configured to provide a wearable computer (e.g., controller 14) that includes a head up display or an optical head-mounted display (e.g., display portion 20).

For purposes of illustrating certain example features of electronic device 10, the following foundational information may be viewed as a basis from which the present disclosure may be properly explained. Because the human eye is not able to properly focus on near or close objects, existing optical head-mounted display products often mount the display someplace other than in front of the eye and require set of optics to bring the image in front of the eye. As a result, heads up displays (or optical head-mounted displays) on the market today are typically considered heavy, obtrusive, non-discreet, or bulky and, due to their design, can often create stress when used for extended periods of time.

Particular embodiments described herein provide for an electronic device, such as an optical head-mounted display, configured to reduce the complexity and size of the required optics necessary to bring a display in front of an eye of a user. Electronic device 10 can include a display and a lens portion. The distance between the display and the lens portion may be a few millimeters (e.g., less than about 5 millimeters (mm)). The focal length or distance of the lens portion can cause a virtual image to appear between the display and the lens portion at a virtual focal point. The lens portion can include a plurality of micro lenses and another lens or a group of lenses. Each micro lens in the plurality of micro lenses may be about the size of a pixel on the display. When a micro lens is placed close enough to a pixel (to avoid the light from neighboring pixels), the micro lens can bend the light from the pixel to create a virtual image of the pixel at a distance that the eye can detect. The other lens in the lens portion may be a plano-convex lens or some other similar lens. The plano-convex lens (or biconvex lens) allows a collimated beam of light, whose rays are parallel while travelling parallel to a lens axis and passing through the lens, to be converged (or focused) to a spot on the axis, at a certain distance (known as the focal length) behind the lens.

The group of lenses in the lens portion may be a Fresnel lens or some other similar group of lenses. The Fresnel lens allows for the construction of lenses of large aperture and short focal length without the mass and volume of material that would be required by a lens of conventional design. The Fresnel lens can be made thinner than a comparable conventional lens (e.g., the plano-convex lens) and can capture more oblique light from a light source. The Fresnel lens uses less material, compared to a conventional lens, by dividing the lens into a set of concentric annular sections. Used together, the plurality of micro lenses and the other lens or group of lenses can create a virtual image of a display at a distance that an eye of a user can properly focus on and visualize.

Electronic device 10 can be mounted on an eyeglass frame and positioned just in front of one eye next to a single lens of the eyeglass. Electronic device 10 can also include a camera to capture gestures and to allow a user to define a viewpoint or virtual plane by intersecting two opposite corners of the display as seen on the virtual image. The camera may be mounted on electronic device 10 or mounted on the frame of the eyeglasses. The camera (and electronic device 10) can be configured to allow a hand of the user to be used as a pointing device to control a cursor or interact with images on the display. Such a configuration can also be used to simulate a click of a computer mouse, such as when the thumb and another finger touch.

In one or more embodiments, electronic device 10 can function as a computer (e.g., notebook computer, laptop, tablet computer or device), a cellphone, a personal digital assistant (PDA), a smartphone, an audio system, a movie player of any type, or other device that includes a circuit board coupled to a plurality of electronic components (which includes any type of components, elements, circuitry, etc.). Electronic device 10 can include a battery and various electronics (e.g., processor, memory, etc.) to allow electronic device 10 to function as a head up display or interactive heads up display. In another embodiment, electronic device 10 can include a wireless module (e.g., Wi-Fi module, Bluetooth module, any suitable 802 protocol, etc.) that allows electronic device 10 to communicate with a network or other electronic devices. Electronic device 10 may also include a microphone and speakers.

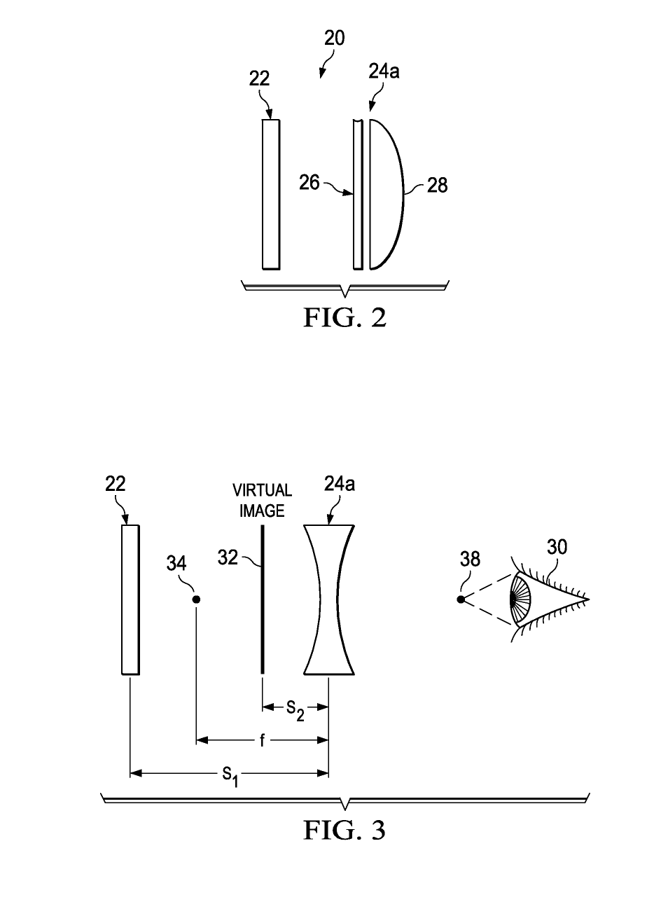

Turning to FIG. 2, FIG. 2 is a simplified orthographic view illustrating display portion 20 of electronic device 10 in accordance with one embodiment of the present disclosure. Display portion 20 may include a display 22, and a lens portion 24a. Lens portion 24a may include a micro lens array 26 and a plano-convex lens 28. In one embodiment, lens portion 24a may include more than one plano-convex lens or some other lens or group of lenses that can focus the light from display 22. The distance between display 22 and micro lens array 26 may be a few millimeters (e.g., less than about 5 millimeters (mm)). In one specific example (similar to that illustrated in FIG. 2), an off-the-shelf 10 mm×10 mm micro lens array (with 150 micron pitch diameter and 5 mm focal lens distance) and a plano-convex lens with a 10 mm diameter were used as lens portion 24a. At a few millimeters from an eye of a user, a picture (e.g., display 22) viewed through the lenses was focused and clear.

FIG. 3 is a simplified side view illustrating display portion 20 of electronic device 10 in accordance with one embodiment of the present disclosure. Light from display 22 can pass through lens portion 24a and converge on virtual focal point 34 and focal point 38. Lens portion 24a can cause an eye 30 of a user to see a virtual image 32 in front of virtual; focal point 34. The perceived location of virtual image 32 depends on the focal length (and resulting virtual focal point 34) of lens portion 24a. Virtual focal point 34 causes virtual image 32 to appear far enough from eye 30 that a user can properly focus on and see virtual image 32.

Similar to curved mirrors, thin lenses follow a simple equation that determines the location of virtual image 32. The equation is (1/(S_{—}1)+1/(S_{—}2)=1/f) where f is the focal length, S_{—}1 is the object (e.g., display 22) distance from the lens, and S_{—}2 is the distance associated with the image. By convention, the distance associated with the image is considered to be negative if it is on the same side of the lens as the object and positive if it is on the opposite side of the lens. Thin lenses produce focal points on either side (e.g., virtual focal point 34 and focal point 38) that can be modeled using what is commonly known as the lensmaker's equation (P=1/f=(n−1)((1−R1)−(1/R2)+((n−1)d)/(nR1R2))). Where P is the power of the lens, f is the focal length of the lens, n is the refractive index of the lens material, R_{—}1 is the radius of curvature of the lens surface closest to the light source, R_{—}2 is the radius of curvature of the lens surface farthest from the light source, and d is the thickness of the lens.

Snell's law (also known as the Snell-Descartes law or the law of refraction) is a formula used to describe the relationship between the angles of incidence and refraction when referring to light or other waves passing through a boundary (e.g., lens portion 24a) between isotropic media, such as water, glass, and air. Snell's law states that the ratio of the sines of the angles of incidence and refraction is equivalent to the ratio of phase velocities in the two media, or equivalent to the reciprocal of the ratio of the indices of refraction (i.e., (sin\theta_{—}1)\(sin\theta_{—}2)=(v_{—}1)/(v_{—}2)=(n_{—}2)/(n_{—}1) where theta as the angle measured from the normal of the boundary, v as the velocity of light in the respective medium (SI units are meters per second, or m/s) and n as the refractive index (which is can be unit less) of the respective medium.

Incoming parallel rays are focused by plano-convex lens 28 into an inverted image one focal length from the lens on the far side of the lens. Rays from an object at a finite distance are focused further from the lens than the focal distance, (i.e., the closer the object is to the lens, the further the image is from the lens). Rays from an object at finite distance are associated with a virtual image that is closer to the lens than the focal length and on the same side of the lens as the object. The closer the object is to the lens, the closer the virtual image is to the lens.

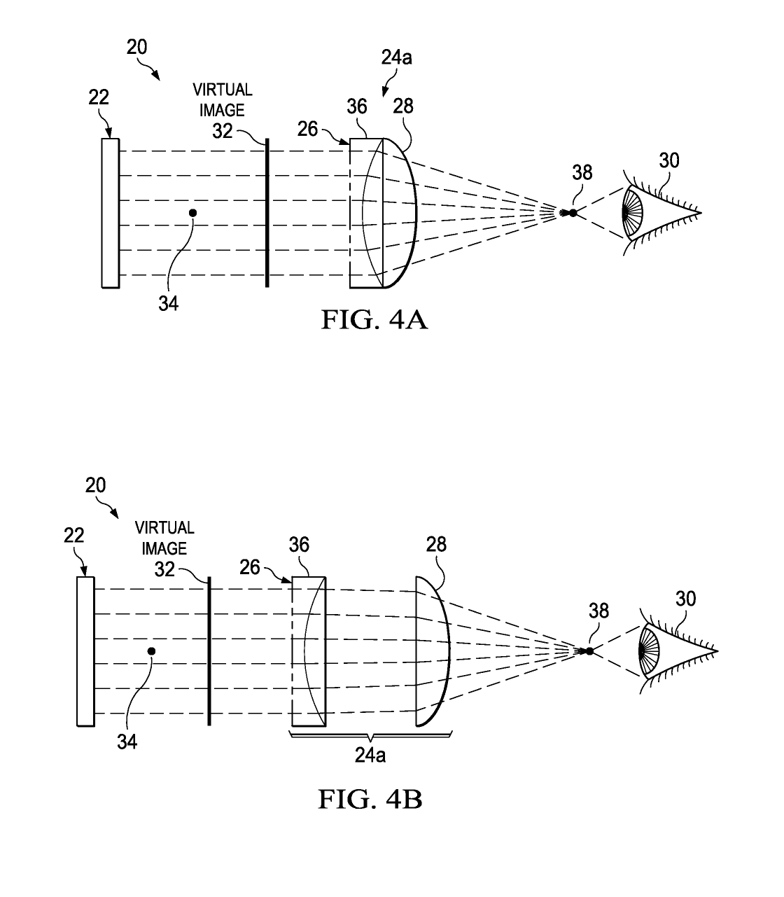

Referring now to FIG. 4A, FIG. 4A is a simplified side view illustrating display portion 20 of electronic device 10 in accordance with one embodiment of the present disclosure. Display portion 20 can include display 22 and lens portion 24a. Lens portion 24a can include micro lens array 26, a substrate 36, and plano-convex lens 28. Plano-convex lens 28 may be on or attached to substrate 36. Substrate 36 may be glass or some other similar material that allows light to pass through and provides support for lens portion 24a. Light from display 22 can pass through micro lens array 26 and substrate 36 to plano-convex lens 28. Plano-convex lens 28 can focus the light to focal point 38. Eye 30 (of a user) can then view a virtual image (e.g., virtual image 32) of display 22.

Turning to FIG. 4B, FIG. 4B is a simplified side view illustrating display portion 20 of electronic device 10 in accordance with one embodiment of the present disclosure. Display portion 20 can include display 22 and lens portion 24a. Lens portion 24a can include micro lens array 26, substrate 36, and plano-convex lens 28. Plano-convex lens 28 may be separate from substrate 36. Light from display 22 can pass through micro lens array 26 and substrate 36 to plano-convex lens 28. Plano-convex lens 28 can focus the light to focal point 38. Eye 30 can then view a virtual image (e.g., virtual image 32) of display 22.

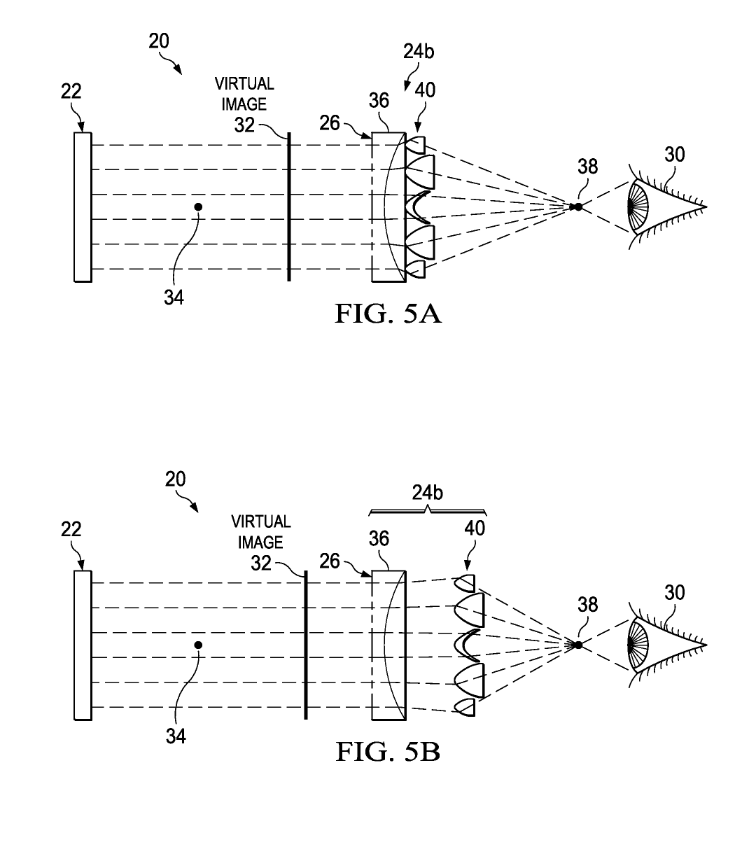

Referring now to FIG. 5A, FIG. 5A is a simplified side view illustrating display portion 20 of electronic device 10 in accordance with one embodiment of the present disclosure. Display portion 20 can include display 22 and lens portion 24b. Lens portion 24b can include micro lens array 26, substrate 36, and a Fresnel lens 40. Fresnel lens 40 may be on or attached to substrate 36. Light from display 22 can pass through micro lens array 26 and substrate 36 to Fresnel lens 40. Fresnel lens 40 can focus the light to focal point 38. Eye 30 can then view a virtual image (e.g., virtual image 32) of display 22.

Turning to FIG. 5B, FIG. 5B is a simplified side view illustrating display portion 20 of electronic device 10 in accordance with one embodiment of the present disclosure. Display portion 20 can include display 22 and lens portion 24b. Lens portion 24b can include micro lens array 26, substrate 36, and Fresnel lens 40. Fresnel lens 40 may be separate from substrate 36. Light from display 22 can pass through micro lens array 26 and substrate 36 to Fresnel lens 40. Fresnel lens 40 can focus the light to focal point 38. Eye 30 can then view a virtual image (e.g., virtual image 32) of display 22.

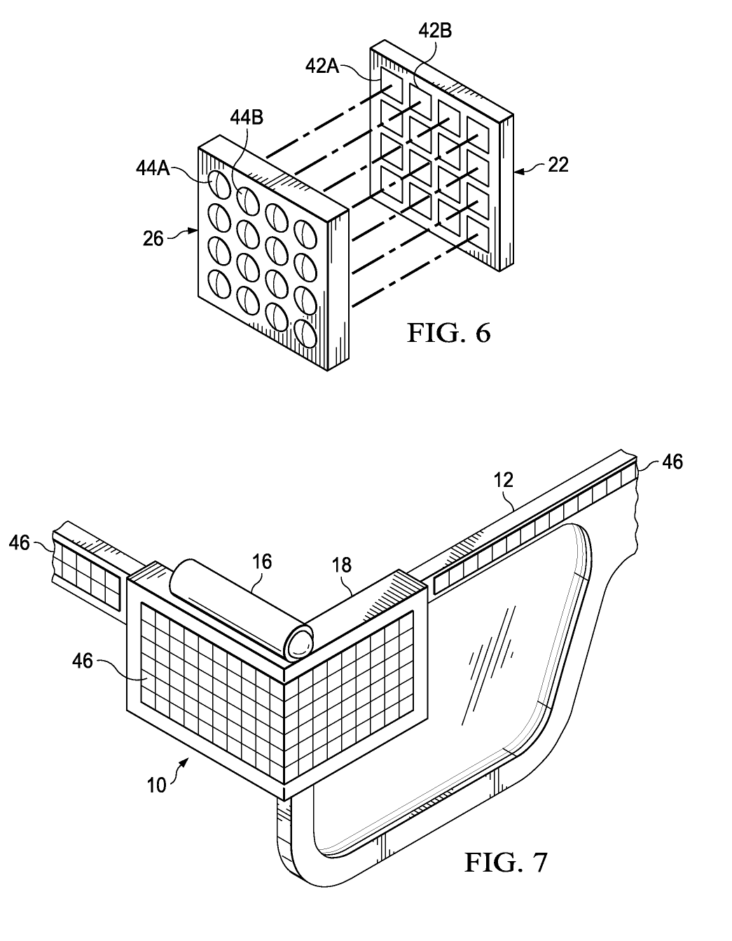

Referring now to FIG. 6, FIG. 6 is a simplified orthographic view of an electronic device 10 in accordance with one embodiment of the present disclosure. Display 22 can include a plurality of pixels (e.g., pixels 42a and 42b are illustrated in FIG. 6). Micro lens array 26 can include a plurality of lenses (e.g., lens 44a and 44b are illustrated in FIG. 6). In an embodiment, each lens in micro lens array 26 lines up with a corresponding pixel in display 22. For example, lens 44a lines up with pixel 42a such that the light from pixel 42a passes through lens 44a and stray light from pixel 42b does not pass through lens 44a (or very little stray light from pixel 42b does not pass through lens 44a). In addition, lens 44b lines up with pixel 42b such that the light from pixel 42b passes through lens 44b and stray light from pixel 42a does not pass through lens 44b (or very little stray light from pixel 42a does not pass through lens 44b). As the light from display 22 passes through micro lens array 26, the light from each pixel is focused to allow the lens portion 24a (or 24b) to create a virtual image of display 22 at a distance that the eye of the user can properly focus on and see.

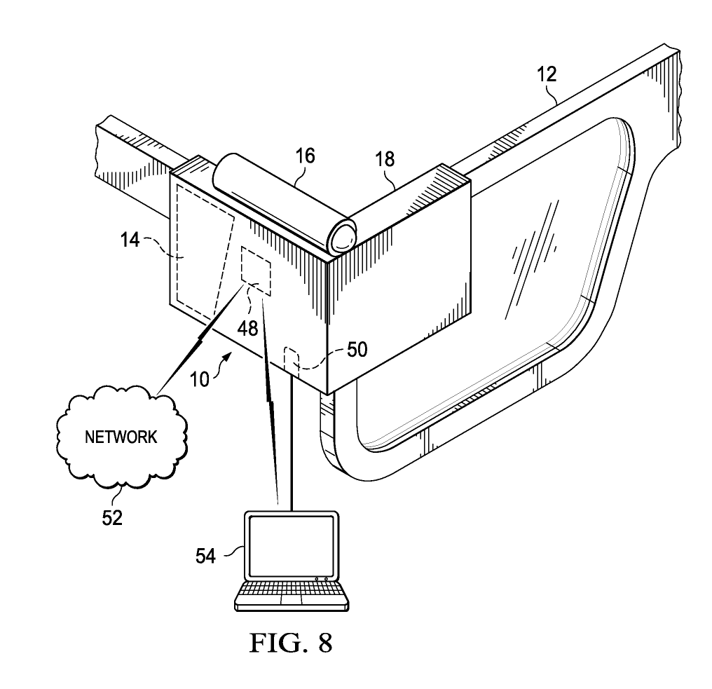

FIG. 7 is a simplified orthographic view illustrating an embodiment of an electronic device 10 on eyeglasses 12 in accordance with one embodiment of the present disclosure. Body portion 18 may include solar cells 46. In addition, eyeglasses 12 may also include solar cells 46. Solar cells 46 can harvest light rays and cause an electrical current and signals to recharge an on-board battery or capacitor or power any number of items (e.g., display 22, a wireless module, camera 16, speakers, etc.).

FIG. 8 is a simplified orthographic view illustrating an embodiment of an electronic device 10 on eyeglasses 12 in accordance with one embodiment of the present disclosure. Body portion 18 may include a wireless module 48, or an interconnect 50 or both. Wireless module 48 may allow electronic device 10 to wirelessly communicate with a network 52 and/or a second electronic device 54 through a wireless connection.

Second electronic device 54 may be a computer (e.g., notebook computer, laptop, tablet computer or device), a cellphone, a personal digital assistant (PDA), a smartphone, an audio system, a movie player of any type, router, access point, or other device that includes a circuit board coupled to a plurality of electronic components (which includes any type of components, elements, circuitry, etc.). The wireless connection may be any 3G/4G/LTE cellular wireless, WiFi/WiMAX connection, or some other similar wireless connection. In an embodiment, the wireless connection may be a wireless personal area network (WPAN) to interconnect electronic device 10 to network 52 and/or second electronic device 54 within a relatively small area (e.g., Bluetooth™, invisible infrared light, Wi-Fi, etc.). In another embodiment, the wireless connection may be a wireless local area network (WLAN) that links electronic device 10 to network 52 and/or second electronic device 54 over a relatively short distance using a wireless distribution method, usually providing a connection through an access point for Internet access. The use of spread-spectrum or OFDM technologies may allow electronic device to move around within a local coverage area, and still remain connected to network 52 and/or second electronic device 54.

Interconnect 50 may allow electronic device to communicate with network 52 and/or second electronic device 54 (or both). Electrical current and signals may be passed through a plug-in connector (e.g., whose male side protrusion connects to electronic device 10 and whose female side connects to second electronic device 54 (e.g., a computer, laptop, router, access point, etc.) or vice-verse). Note that any number of connectors (e.g., Universal Serial Bus (USB) connectors (e.g., in compliance with the USB 3.0 Specification released in November 2008), Thunderbolt™ connectors, category 5 (cat 5) cable, category 5e (cat 5e) cable, a non-standard connection point such as a docking connector, etc.) can be provisioned in conjunction with electronic device 10. [Thunderbolt™ and the Thunderbolt logo are trademarks of Intel Corporation in the U.S. and/or other countries.]. Virtually any other electrical connection methods could be used and, thus, are clearly within the scope of the present disclosure.

Network 52 may be a series of points or nodes of interconnected communication paths for receiving and transmitting packets of information that propagate through network 52. Network 52 offers a communicative interface and may be any local area network (LAN), wireless local area network (WLAN), metropolitan area network (MAN), Intranet, Extranet, WAN, virtual private network (VPN), or any other appropriate architecture or system that facilitates communications in a network environment. Network 52 can comprise any number of hardware or software elements coupled to (and in communication with) each other through a communications medium.

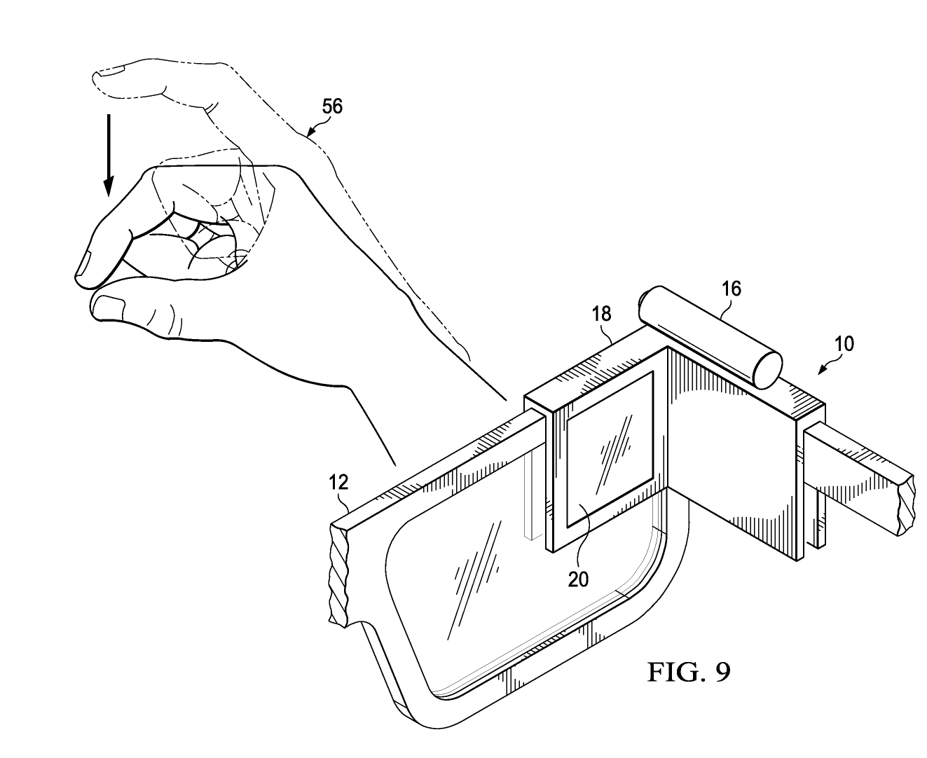

FIG. 9 is a simplified orthographic view illustrating an embodiment of an electronic device 10 on eyeglasses 12 in accordance with one embodiment of the present disclosure. In use, movement of a hand 56 of a user may be detected and captured by camera 16. The movement of hand 56 may be used to capture pre-defined gestures. The captured movement or gestures of hand 56 may be processed by controller 14 to allow hand 56 to be used as a pointing device to control a cursor (similar to a mouse) or interact with images on display 22. Such a configuration can also be used to simulate the click of a mouse, such as a gesture where the thumb and another finger on hand 56 touch.

In addition, movement of hand 56 may be detected and captured by camera 16 to allow the user to define a viewpoint by intersecting two opposite corners of the display as seen on a virtual image. In an embodiment, when electronic device 10 is activated (or turned on), the user can use hand gestures to define a virtual plane in space as seen by the user that matches the actual screen display. For example, the user may define the viewpoint by intersecting two opposite corners of the display as seen on the virtual image. Any hand gestures made outside of the virtual plane will not be detected or acted upon by the electronic device 10. Electronic device 10 will only respond to hand movement or gestures made inside the virtual plane,

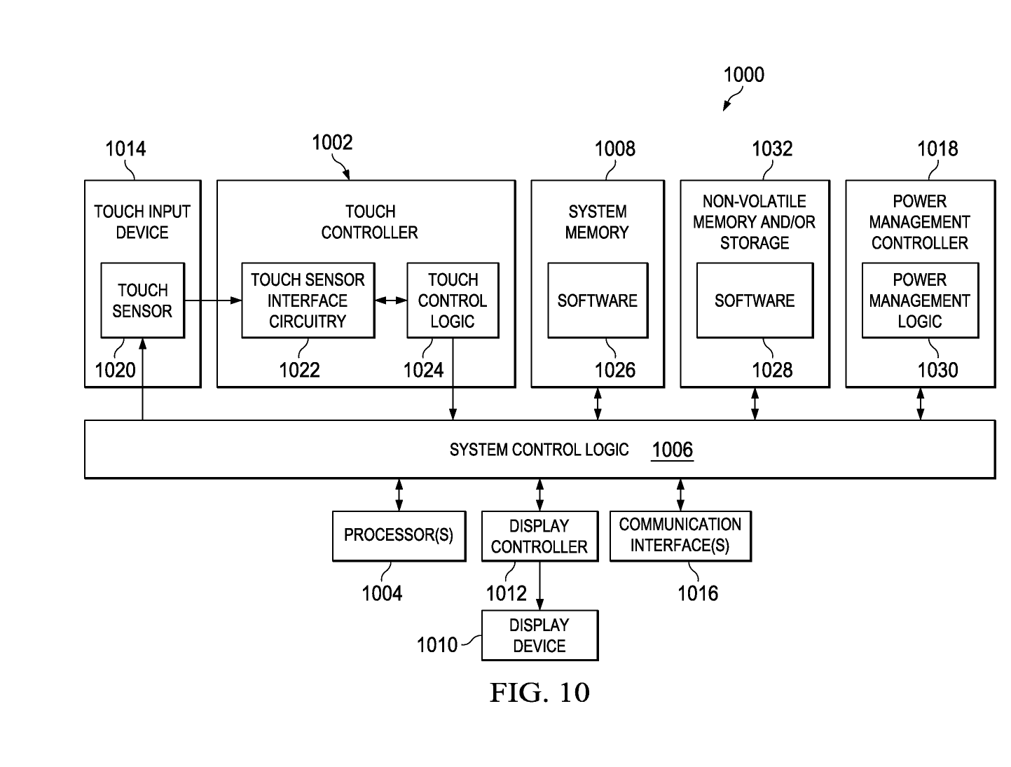

FIG. 10 is a simplified block diagram illustrating potential electronics and logic that may be associated with electronic device 10 as discussed herein. In at least one example embodiment, system 1000 can include a touch controller 1002 (e.g., for set of contact switches), one or more processors 1004, system control logic 1006 coupled to at least one of processor(s) 1004, system memory 1008 coupled to system control logic 1006, non-volatile memory and/or storage device(s) 1032 coupled to system control logic 1006, display controller 1012 coupled to system control logic 1006, display controller 1012 coupled to a display device 1010, power management controller 1018 coupled to system control logic 1006, and/or communication interfaces 1016 coupled to system control logic 1006.

Hence, the basic building blocks of any computer system (e.g., processor, memory, I/O, display, etc.) can be used in conjunction with the teachings of the present disclosure. Certain components could be discrete or integrated into a System on Chip (SoC). Some general system implementations can include certain types of form factors in which system 1000 is part of a more generalized enclosure.

System control logic 1006, in at least one embodiment, can include any suitable interface controllers to provide for any suitable interface to at least one processor 1004 and/or to any suitable device or component in communication with system control logic 1006. System control logic 1006, in at least one embodiment, can include one or more memory controllers to provide an interface to system memory 1008. System memory 1008 may be used to load and store data and/or instructions, for example, for system 1000. System memory 1008, in at least one embodiment, can include any suitable volatile memory, such as suitable dynamic random access memory (DRAM) for example. System control logic 1006, in at least one embodiment, can include one or more I/O controllers to provide an interface to display device 1010, touch controller 1002, and non-volatile memory and/or storage device(s) 1032.

Non-volatile memory and/or storage device(s) 1032 may be used to store data and/or instructions, for example within software 1028. Non-volatile memory and/or storage device(s) 1032 may include any suitable non-volatile memory, such as flash memory for example, and/or may include any suitable non-volatile storage device(s), such as one or more hard disc drives (HDDs).

Power management controller 1018 may include power management logic 1030 configured to control various power management and/or power saving functions. In at least one example embodiment, power management controller 1018 is configured to reduce the power consumption of components or devices of system 1000 that may either be operated at reduced power or turned off when the electronic device is in a standby state or power off state of operation. For example, in at least one embodiment, when the electronic device is in a standby state, power management controller 1018 performs one or more of the following: power down the unused portion of the display and/or any backlight associated therewith; allow one or more of processor(s) 1004 to go to a lower power state if less computing power is required in the standby state; and shutdown any devices and/or components that are unused when an electronic device is in the standby state.

Communications interface(s) 1016 may provide an interface for system 1000 to communicate over one or more networks and/or with any other suitable device. Communications interface(s) 1016 may include any suitable hardware and/or firmware. Communications interface(s) 1016, in at least one example embodiment, may include, for example, a network adapter, a wireless network adapter, and/or a wireless modem. System control logic 1006, in at least one embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one embodiment, at least one processor 1004 may be packaged together with logic for one or more controllers of system control logic 1006. In at least one embodiment, at least one processor 1004 may be packaged together with logic for one or more controllers of system control logic 1006 to form a System in Package (SiP). In at least one embodiment, at least one processor 1004 may be integrated on the same die with logic for one or more controllers of system control logic 1006. For at least one embodiment, at least one processor 1004 may be integrated on the same die with logic for one or more controllers of system control logic 1006 to form a System on Chip (SoC).

For touch control, touch controller 1002 may include touch sensor interface circuitry 1022 and touch control logic 1024. Touch sensor interface circuitry 1022 may be coupled to detect touch input from touch input device 1014 (e.g., a set of contact switches or other touch type input). Touch input device 1014 may include touch sensor 1020 to detect contact or a touch. Touch sensor interface circuitry 1022 may include any suitable circuitry that may depend, for example, at least in part on the touch-sensitive technology used for a touch input device. Touch sensor interface circuitry 1022, in one embodiment, may support any suitable multi-touch technology. Touch sensor interface circuitry 1022, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 1024 may be coupled to help control touch sensor interface circuitry 1022 in any suitable manner to detect touch input over a first touch surface layer and a second touch surface layer. Touch control logic 1024 for at least one example embodiment may also be coupled to output in any suitable manner digital touch input data corresponding to touch input detected by touch sensor interface circuitry 1022. Touch control logic 1024 may be implemented using any suitable logic, including any suitable hardware, firmware, and/or software logic (e.g., non-transitory tangible media), that may depend, for example, at least in part on the circuitry used for touch sensor interface circuitry 1022. Touch control logic 1024 for at least one embodiment may support any suitable multi-touch technology.

Touch control logic 1024 may be coupled to output digital touch input data to system control logic 1006 and/or at least one processor 1004 for processing. At least one processor 1004 for at least one embodiment may execute any suitable software to process digital touch input data output from touch control logic 1024. Suitable software may include, for example, any suitable driver software and/or any suitable application software. As illustrated in FIG. 10, system memory 1008 may store suitable software 1026 and/or non-volatile memory and/or storage device(s).

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that a number of operations have been described as being executed concurrently with, or in parallel to, one or more additional operations. However, the timing of these operations may be altered considerably. The preceding examples and operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, and relationships outlined herein (e.g., specific commands, timing intervals, supporting ancillary components, etc.) have only been offered for purposes of example and teaching only. Each of these may be varied considerably without departing from the spirit of the present disclosure, or the scope of the appended claims. The specifications apply to many varying and non-limiting examples and, accordingly, they should be construed as such. In the foregoing description, examples have been described. Various modifications and changes may be made to such examples without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

Particular embodiments described herein provide for an electronic device that can include a circuit board coupled to a plurality of electronic components (which may include any type of components, elements, circuitry, etc.). One particular example implementation of an electronic device may include a display portion that includes: a display provided in front of an eye of a user; and a lens portion that includes a micro lens array and a convex lens, where the micro lens array and the convex lens cooperate in order to render a virtual image of an object to the user.

In other embodiments, the virtual image is rendered between the display and the convex lens. The micro lens array can comprise at least one Fresnel lens. In addition, the display can include a plurality of pixels and the micro lens array includes a plurality of lenses, and each lens in the plurality of lenses corresponds to a pixel in the plurality of pixels. In certain embodiments, the electronic device can include a camera configured to allow the user to define a viewpoint for the virtual image. The camera is configured to capture at least one hand motion by the user for interaction with the display. In at least one embodiment, the distance between the display and the micro lens array is less than five (5) millimeters.

What is claimed is:

1. An electronic device, comprising:
a display portion that includes:
a display to be provided in front of an eye of a user; and
a lens portion that includes a micro lens array and a convex lens, wherein the micro lens array and the convex lens cooperate in order to render a virtual image of an object to the user.

2. The electronic device of claim 1, wherein the virtual image is rendered between the display and the convex lens.

3. The electronic device of claim 1, wherein the micro lens array comprises at least one Fresnel lens.

4. The electronic device of claim 1, wherein the display includes a plurality of pixels and the micro lens array includes a plurality of lenses, and wherein each lens in the plurality of lenses corresponds to a pixel in the plurality of pixels.

5. The electronic device of claim 1, further comprising a camera configured to allow the user to define a viewpoint for the virtual image.

6. The electronic device of claim 5, wherein the camera is configured to capture at least one hand motion by the user for interaction with the display.

7. The electronic device of claim 1, wherein the distance between the display and the micro lens array is less than five (5) millimeters.

8. An electronic device, comprising:
a display portion for mounting on eyeglasses to be worn by a user, the display portion comprising:
a display to be provided in front of an eye of the user; and
a lens portion that includes a micro lens array and a convex lens, wherein the micro lens array and the convex lens cooperate in order to render a virtual image of an object to the user.

9. The electronic device of claim 8, wherein the display includes a plurality of pixels and the micro lens array includes a plurality of lenses, wherein each lens in the plurality of lenses corresponds to a pixel in the plurality of pixels.

10. The electronic device of claim 8, wherein the virtual image is rendered between the display and the convex lens.

11. The electronic device of claim 8, further comprising a camera configured to allow the user to define a viewpoint for the virtual image.

12. The electronic device of claim 11, wherein the camera can define a virtual plane and hand gestures made outside of the virtual plane are not acted upon by the electronic device.

13. The electronic device of claim 11, wherein the camera facilitates at least one hand gesture that simulates a mouse click of a computing device.

14. The electronic device of claim 8, wherein the distance between the display and the micro lens array is less than five (5) millimeters.

15. A method, comprising:
providing a display in front of an eye of the user; and
rendering a virtual image of an object to the user via a lens portion that includes a micro lens array and a convex lens.

16. The method of claim 15, wherein the display includes a plurality of pixels and the micro lens array includes a plurality of lenses, wherein each lens in the plurality of lenses corresponds to a pixel in the plurality of pixels.

17. The method of claim 15, wherein the virtual image is rendered between the display and the convex lens.

18. The method of claim 15, further comprising:
providing a camera configured to allow the user to define a viewpoint for the virtual image.

19. The method of claim 18, wherein the camera can define a virtual plane and hand gestures made outside of the virtual plane are not acted upon by an associated electronic device.

20. The method of claim 18, wherein the camera facilitates at least one hand gesture that simulates a mouse click of a computing device.

21. A system, comprising:
means for providing a display in front of an eye of the user; and
means for rendering a virtual image of an object to the user, wherein the means for rendering includes, at least, a lens portion that includes a micro lens array and a convex lens.

22. The system of claim 21, wherein the display includes a plurality of pixels and the micro lens array includes a plurality of lenses, wherein each lens in the plurality of lenses corresponds to a pixel in the plurality of pixels.

23. The system of claim 21, wherein the virtual image is rendered between the display and the convex lens.

24. The system of claim 21, wherein a camera is provided adjacent to the display and is configured to allow the user to define a viewpoint for the virtual image.

25. The system of claim 24, wherein the camera facilitates at least one hand gesture that simulates a mouse click of a computing device.

26. The system of claim 24, further comprising:
means for providing a wireless connection between the system and at least one electronic device.
